(19) United States
(12) Patent Application Publication
(10) Pub. No.: US 2020/0071177 A1
(43) Pub. Date: Mar. 5, 2020

(54) PROCESS FOR PREPARING AN ELECTRIDE COMPOUND

(71) Applicant: BASF SE, Ludwigshafen am Rhein (DE)

(72) Inventors: Stephan A. SCHUNK, Heidelberg (DE); Sebastian SCHAEFER, Heidelberg (DE); Jaroslaw Michael MORMUL, Ludwigshafen am Rhein (DE); Andrei-Nicolae PARVULESCU, Ludwigshafen am Rhein (DE); Grigorios KOLIOS, Ludwigshafen am Rhein (DE); Torsten MATTKE, Ludwigshafen am Rhein (DE); Frank ROSOWSKI, Ludwigshafen am Rhein (DE)

(21) Appl. No.: 16/604,644

(22) PCT Filed: Apr. 11, 2018
(86) PCT No.: PCT/EP2018/059232

§ 371 Date: Oct. 11, 2019

(30) Foreign Application Priority Data
Apr. 11, 2017 (EP) 17166004.6

(51) Int. Cl. C01F 7/16; C01F 17/00; B01J 23/10; B01J 23/02; B01J 37/34; B01J 37/10

(52) U.S. Cl. CPC C01F 7/164; C01F 17/0025; B01J 23/10; B01J 23/02; C01P 2002/80; B01J 37/349; B01J 37/10; C01P 2002/72; B01J 37/342

(57) ABSTRACT

A process for preparing an electride compound, comprising (i) providing a precursor compound comprising an oxidic compound of the garnet group; (ii) heating the precursor provided in (i) under plasma forming conditions in a gas atmosphere to a temperature of the precursor above the Hüttig temperature of the precursor, obtaining the electride compound.

The present invention relates to a process for preparing an electride compound under plasma forming conditions, preferably a process for preparing an electride compound in an electric arc, preferably an ultrafast process in an electric arc. Further, the present invention relates to an electride compound as such and an electride compound which is obtainable by the process of the invention, and to the use of said electride compound, preferably as a catalyst or a catalyst component.

Electride compounds are ionic compounds in which the anions are partially or completely formed by electrons. In particular, in electride compounds, the electrons are not bound to specific atoms or molecules but are located in cavities and/or interspaces of the respective host system, as described, for example, in Y. Nishio et al. In these electride compounds, the electrons act as anions by compensating the positive charge of the framework of the host system. The first electride compounds discovered were alkali metal-ammonia solution containing solvated electrons wherein the characteristic blue color of said solutions serves a proof for the existence of free electrons. In 1983, the first crystalline organic electride Cs⁺(18-crown-6)2(e⁻) was synthesized (J. L. Dye). Subsequently, a whole variety of organic electride compounds was prepared which consisted of alkali metal ions and organic complex forming compounds. These electrides are characterized in that they are stable only under inert conditions at temperatures of up to −40° C. Due to these stability issues, a technical and an industrial use were not possible.

US 2006/0151311 A1 discloses a method for preparing an inorganic electride compound (12CaO7Al₂O₃) comprising treating a suitable precursor compound at certain elevated temperatures for 240 h. The same holding time of 240 h is disclosed in the later published US 2009/0224214 A1. In a subsequent publication, the preparation of an electride compound was disclosed, comprising a heat treatment of a precursor compound in vacuum (10⁻⁴ Pa) at 800° C. for 15 h (US 2015/0217278 A1). For a commercially interesting production of electride materials, there was thus the need to provide a process allowing for much lower synthesis times, preferably for synthesis times of at most or less than 1 h, more preferably of at most or less than 10 min, more preferably of at most or less than 5 min. According to the present invention, this problem was solved by providing a process wherein a suitable precursor compound is subjected to a heat treatment under specific heating conditions.

Therefore, the present invention relates to a process for preparing an electride compound, comprising
(i) providing a precursor compound of the electride compound, wherein the precursor compound comprises an oxidic compound of the gamet group;
(ii) heating the precursor compound provided in (i) under plasma forming conditions in a gas atmosphere to a temperature of the precursor compound above the Hüttig temperature of the precursor compound, obtaining the electride compound.

The term “heating the precursor compound to a temperature . . . ” as used herein is the time necessary for heating the precursor from a starting temperature to said temperature plus the time the precursor is kept at this at this temperature.

The Hüttig temperature of the oxidic precursor compound as well-known by the skilled person is the temperature necessary for the surface recrystallization of the oxidic precursor compound, wherein specifically, the Hüttig temperature is 0.26 T_{M}, T_{M} being the absolute melting temperature of the oxidic precursor compound.

Preferably, according to (ii), the precursor compound provided in (i) is heated under plasma forming conditions in a gas atmosphere to a temperature of the precursor compound above the Tamman temperature of the precursor compound.

The Tamman temperature of the oxidic precursor compound as well-known by the skilled person is the temperature necessary for the lattice (bulk) recrystallization of the oxidic precursor compound, wherein specifically, the Tamman temperature is 0.52 T_{M}, T_{M} being the absolute melting temperature of the oxidic precursor compound.

More preferably, according to (ii), the precursor compound provided in (i) is heated under plasma forming conditions in a gas atmosphere to a temperature of the precursor compound above the melting temperature of the precursor compound.

Regarding the plasma forming conditions according to (ii), no specific limitations exist, provided that the plasma forming conditions are suitable to generate the above defined temperatures above which the precursor is to be heated according to (ii). Preferably, the plasma forming conditions according to (ii) comprise heating the precursor compound in an electric arc, more preferably in an electric arc and a gas atmosphere which is suitable for generating a plasma. The term “plasma” as used herein describes a mixture of particles on an atomic-molecular level the components of which are ions and electrons.

Therefore, the present invention preferably relates to a process for preparing an electride compound, comprising
(i) providing a precursor compound of the electride compound, wherein the precursor compound comprises an oxidic compound of the gamet group;
(ii) heating the precursor compound provided in (i) in an electric arc in a gas atmosphere to a temperature of the precursor compound above the Hüttig temperature, preferably above the Tamman temperature, more preferably above the melting temperature of the precursor compound, obtaining the electride compound.

Using these heating conditions according to (ii), it was found to be possible to significantly reduce the total heating times described in the prior art.

Therefore, the present invention preferably relates to a process for preparing an electride compound, comprising
(i) providing a precursor compound of the electride compound, wherein the precursor compound comprises an oxidic compound of the gamet group;
(ii) heating the precursor compound provided in (i) in an electric arc in a gas atmosphere to a temperature of the precursor compound above the Hüttig temperature, preferably above the Tamman temperature, more preferably above the melting temperature of the precursor compound, obtaining the electride compound,
   wherein the total heating time according to (ii) is at most 1 h, more preferably at most 30 min, more preferably at most 10 min, more preferably at most 5 min.

More preferably, the present invention relates to a process for preparing an electride compound, comprising
(i) providing a precursor compound of the electride compound, wherein the precursor compound comprises an oxidic compound of the gamet group;
(ii) heating the precursor compound provided in (i) in an electric arc in a gas atmosphere to a temperature of the precursor compound above the Hüttig temperature, preferably above the Tamman temperature, more preferably above the melting temperature of the precursor compound, obtaining the electride compound,
   wherein the total heating time according to (ii) is in the range of from 2 to 120 s, more preferably in the range of from 5 to 90 s.

According to the definition above, said total heating time according to (ii) is the time for heating the precursor compound to said temperature plus the time for which the precursor compound is kept at this temperature.

The term “oxidic compound of the gamet group” as used in the context of the present invention, also referred to as “oxidic compound of the gamet mineral group” or “oxidic compound of the garnet supergroup” relates to a compound which comprises oxygen and which is isostructural with gamet regardless of what elements occupy the four atomic sites, wherein the general formula of the gamet supergroup minerals is {X₃}[Y₂]{Z₃}A₁₂, wherein X, Y and Z refer to dodecahedral, octahedral, and tetrahedral sites, respectively, and A is O, OH, or F. Most gamets are cubic, space group Ia-3d, and two OH bearing species have tetragonal symmetry, space group I4₁/acd. Reference is made, for example, to E. S. Grew et al.

Preferably, the oxidic compound of the gamet group according to (i) comprises one or more of calcium and yttrium, more preferably calcium, preferably at the X site. Preferably, the oxidic compound of the gamet group according to (i) comprises aluminum, preferably at Y and/or Z site. Further, the oxidic compound of the gamet group according to (i) may further comprise one or more of magnesium, gallium, silicon, germanium, tin, strontium, titanium, zirconium, chromium, manganese, iron, cobalt, nickel, copper, and zinc.

Preferably at least 90 weight-%, more preferably at least 95 weight-%, more preferably at least 99 weight-%, more preferably at least 99.5 weight-%, more preferably at least 99.9 weight-% of the oxidic compound of the gamet group according to (i) consist of calcium, aluminum, and oxygen. Preferably, the oxidic compound of the gamet group according to (i) comprises calcium and aluminum at an elemental ratio Ca:Al in the range of from 11.5:14 to 12.5:14, more preferably in the range of from 11.8:14 to 12.2:14, more preferably in the range of from 11.9:14 to 12.1:14. More preferably, the oxidic compound of the garnet group according to (i) comprises calcium and aluminum at an elemental ratio Ca:Al of 12:14.

Preferably, the oxidic compound of the gamet group according to (i) comprises calcium and oxygen at an elemental ratio Ca:O in the range of from 11.5:33 to 12.5:33, more preferably in the range of from 11.8:33 to 12.2:33, more preferably in the range of from 11.9:33 to 12.1:33. More preferably the oxidic compound of the garnet group according to (i) comprises calcium and oxygen at an elemental ratio Ca:O of 12:33.

Preferably, the oxidic compound of the garnet group is a crystalline material exhibiting cubic structure and crystallographic space group I-43d. More preferably the oxidic compound of the garnet group comprises, preferably is a mayenite. More preferably, the oxidic compound of the garnet group comprises, preferably is a compound Ca₁₂Al₁₄O₃₃. It is noted that according to the present invention, the mineral mayenite Ca₂Al₁₄O₃₃ which has the space group I-43d and a lattice constant of 1198 pm, and further derivatives thereof, is/are defined as being encompassed by the garnet supergroup of minerals and structures mentioned above.

Generally, in the precursor compound, side phases may occur which can be oxides or hydroxides of the single oxides or of a mixed oxide phase. Examples of such side phases include, but are not restricted to, calcium oxide, aluminum oxides like alpha alumina, theta alumina or gamma alumina, mixed calcium aluminum oxides like Ca₃Al₂O₆ (tricalcium aluminate) or CaAl₂O₃ (krotite). Preferably, at least 80 weight-%, more preferably at least 85 weight-%, more preferably at least 90 weight-%, more preferably at least 95 weight-%, more preferably at least 99 weight-% of the precursor compound consist of an oxidic compound of the gamet group.

Preferably, the precursor compound provided according to (i) has a BET specific surface area, determined according to ISO 9277 via physisorption of nitrogen at 77 K, of at least 2 m²/g, more preferably of at least 3 m²/g, more preferably of at least 5 m²/g, such in the range of from 2 to 1000 m²/g, or in the range of from 3 to 1000 m²/g, or in the range of from 5 to 1000 m²/g, more preferably in the range of from 5 to 500 m²/g, more preferably in the range of from 5 to 100 m²/g.

Generally, the precursor compound provided according to (i) can be in the form of a powder having a particle size in the sub-micrometer range. Preferably, the precursor compound provided according to (i) is in the form of particles having a mean particle size, determined as described in Reference Example 1.6, in the range of from 1 to 2000 micrometer, more preferably in the range of from 10 to 500 micrometer, more preferably in the range of from 20 to 200 micrometer.

Generally, the precursor compound can be provided by any suitable method. If suitable, a commercially available precursor compound can be used. Preferably, providing the precursor compound according to (i) comprises
(i.1) preparing a mixture comprising a source of calcium, a source of aluminum, and water;
(i.2) optionally subjecting the mixture prepared in (i.1) to a hydrothermal treatment;
(i.3) calcining the mixture prepared in (i.1), optionally the mixture obtained from (i.2), obtaining the precursor compound.

The source of calcium in (i.1) preferably comprises, more preferably is one or more of a calcium oxide, a calcium hydroxide, a hydrated calcium oxide, and a calcium carbonate. More preferably, the source of calcium comprises, more preferably is a calcium oxide, more preferably CaO. More preferably, the source of calcium is highly pure and comprises, in addition to calcium, oxygen and optionally hydrogen, other elements such as sodium, potassium, halides like chlorine, or sulfur in respective amounts preferably of at most 0.1 weight-%, more preferably of at most 0.01 weight-%, more preferably of at most 0.001 weight-%, based on the total weight of the source of calcium. Preferred ranges are, for example, 0.000001 to 0.1 weight-% or from 0.00001 to 0.01 weight-% or from 0.0001 to 0.001 weight-%.

The source of aluminum in (i.1) preferably comprises, more preferably is one or more of an aluminum hydroxide including one or more of gibbsite, hydrargillite, bayerite, doyleite, nordstrandite, and gel-like amorphous aluminum hydroxide, an aluminum oxyhydroxide (AlO(OH)) including one or more of pseudo-boehmite, boehmite, diaspor, and akdalaite, and an aluminum oxide including one or more of gamma aluminum oxide, chi aluminum oxide, delta aluminum oxide, eta aluminum oxide, rho aluminum oxide and kappa aluminum oxide. More preferably, the source of aluminum comprises, more preferably is one or more of gamma alumina, gamma aluminum oxyhydroxide (boehmite) and a pseudo boehmite, more preferably comprises, more preferably is gamma aluminum oxyhydroxide. More preferably, the source of aluminum is highly pure and comprises, in addition to aluminum, oxygen and optionally hydrogen, other elements such as sodium, potassium, halides like chlorine or sulfur in respective amounts preferably of at most 0.1 weight-%, more preferably of at most 0.01 weight-%, more preferably of at most 0.001 weight-%, based on the total weight of the source of calcium. Preferred ranges are, for example, 0.000001 to 0.1 weight-% or from 0.00001 to 0.01 weight-% or from 0.0001 to 0.001 weight-%. Examples of such sources of aluminum are aluminum hydroxides or aluminum oxides which are obtained by the ALFOL process and which are commercially available as high purity aluminum oxides (“hochreine Tonerden”) by vendors like SASOL. Preferably, the source of aluminum has BET specific surface area determined according to ISO 9277 via physisorption of nitrogen at 77 K, in the range of from 10 to 500 m²/g, more preferably in the range of from 50 to 300 m²/g, more preferably in the range of from 100 to 250 m²/g.

Preferably, in the mixture prepared in (i.1), the molar ratio of the source of calcium relative to the source of aluminum, preferably the molar ratio of the calcium oxide relative to the gamma aluminum oxyhydroxide, is in the range of from 11.90:14 to 12.10:14, more preferably in the range of from 11.95 to 12.05:14, more preferably in the range of from 11.99:14 to 12.01:14. More preferably, the molar ratio of the source of calcium relative to the source of aluminum, preferably the molar ratio of the calcium oxide relative to the gamma aluminum oxyhydroxide, is 12.00:14.00.

Preferably, in the mixture prepared in (i.1), the molar ratio of the water relative to the source of aluminum, preferably the gamma aluminum oxyhydroxide, calculated as elemental aluminum, is in the range of from 0.1:1 to 50:1, preferably in the range of from 0.2:1 to 30:1, more preferably in the range of from 0.3:1 to 20:1, more preferably in the range of from 0.5:1 to 10:1. Preferred ranges are, for example, from 0.5:1 to 2:1 or from 2:1 to 4:1 of from 4:1 to 6:1 or from 6:1 to 8:1 or from 8:1 to 10:1.

Preparing the mixture according to (i.1) can be carried out according any suitable method known by the skilled person. Preferably, preparing the mixture according to (i.1) comprises agitating the mixture, preferably mechanically agitating the mixture. More preferably, mechanically agitating the mixture comprises milling or kneading the mixture, more preferably milling the mixture.

For the calcining according to (i.3), the mixture is preferably calcined in a gas atmosphere, wherein the gas atmosphere comprises nitrogen or oxygen, wherein more preferably, the gas atmosphere is oxygen, air, lean air, or synthetic air. Preferably, the gas atmosphere is a gas stream and the mixture is calcined at a flow rate of the gas stream in the range of from 1 to 10 L/min, more preferably in the range of from 3 to 9 L/min, more preferably in the range of from 5 to 8 L/min. Preferably, the calcining is carried out at a temperature, preferably at a temperature of the gas atmosphere, in the range of from 400 to 1400° C., more preferably in the range of from 500 to 1350° C., more preferably in the range of from 600 to 1300° C., more preferably in the range of from 700 to 1300° C., more preferably in the range of from 750 to 1250° C. Preferably, the mixture is heated to the temperature at a heating rate in the range of from 1 to 8 K/min, more preferably in the range of from 2 to 7 K/min, more preferably in the range of from 3 to 6 K/min.

According to one embodiment of the process of the present invention, a hydrothermal treatment is carried out according to (i.2).

Preferably, according to (i. 2), the mixture is heated under autogenous pressure, more preferably in an autoclave, to a temperature of the mixture in the range of from 35 to 250° C., more preferably in the range of from 40 to 200° C., more preferably in the range of from 50 to 150° C., more preferably in the range of from 50 to 100° C. Preferably, the mixture is kept at this temperature for a period of time of at most 90 h, more preferably at most 70 h, more preferably at most 50 h. More preferably, the mixture is kept at this temperature for a period of time in the range of from 1 to 90 h, more preferably in the range of from 3 to 70 h, more preferably in the range of from 6 to 50 h.

Preferably, (i.2) further comprises drying the mixture obtained from the hydrothermal treatment, preferably in a gas atmosphere, wherein the gas atmosphere preferably comprises oxygen, wherein more preferably, the gas atmosphere is oxygen, air, lean air, or synthetic air, and wherein the gas atmosphere has a temperature preferably in the range of from 40 to 150° C., more preferably in the range of from 50 to 120° C., more preferably in the range of from 60 to 100° C. Prior to drying, the mixture obtained from the hydrothermal treatment can be subjected to filtration optionally followed by washing.

Preferably, if the hydrothermal treatment according to (i.2) is carried out, in the mixture prepared in (i.1), the molar ratio of the water relative to the source of aluminum, preferably the gamma aluminum oxyhydroxide, calculated as elemental aluminum, is preferably in the range of from 0.1:1 to 50:1, more preferably in the range of from 0.2:1 to 30:1, more preferably in the range of from 0.3:1 to 20:1, more preferably in the range of from 0.5:1 to 10:1. Further, if the hydrothermal treatment according to (i.2) is carried out, according to (i. 3), the mixture is calcined in a gas atmosphere, wherein the gas atmosphere preferably comprises nitrogen and/or oxygen, wherein more preferably, the gas atmosphere is oxygen, air, lean air, or synthetic air. The calcination is preferably carried out at a temperature, preferably a temperature of the gas atmosphere used for calcining, in the range of from 400 to 1400° C., more preferably in the range of from 400 to 1200° C., more preferably in the range of from 400 to 1000° C., more preferably in the range of from 400 to 800° C.

According to the present invention, it is possible to use the precursor compound which is obtained in (i.3) without any further post-treatment, for example in the form of a powder which is obtained from (i.3). The use of such a powder may be preferred if, for example, the heating according to (ii) is carried out in a continuous manner. Further, it may be preferred that after (i.3), and according to (i.4), a molding is prepared comprising, preferably consisting of the precursor compound obtained from (i.3). The geometry of the molding provided in (i) is not subject to any specific restrictions. Preferably, the molding is one or more of a flake, a sphere, a tablet, a star, a strand, a brick optionally having one or more channels with an open inlet end and an open outlet end, an optionally hollow cylinder, and a porous foam. Preferably, the molding is in the form of a tablet.

According to (ii), the mixture provided in (i) is heated under plasma-forming conditions.

Heating under plasma forming conditions can be carried out in continuous mode. In order to process the precursor material continuously several modes of operation are feasible. According to a first method, a plasma torch can be moved over a static bed comprising the precursor compound under conditions suitable to form an electride compound wherein the movement of the torch can be circular or unidirectional. According to a second method, a bed comprising the precursor compound is moved under a static plasma torch under conditions suitable to form an electride compound wherein the movement of the precursor material can be circular or unidirectional. According to a third method, a continuous stream comprising the precursor compound having preferably having a defined particle size is fed through a plasma torch. This can either be achieved by feeding a powder comprising the precursor compound through a plasma torch or passing an aerosol comprising the precursor compound through a plasma torch. In this case, the powder of precursor material may preferably have a mean particle size in range of from 0.1 to 2000 micrometer, more preferably in the range of from 0.5 to 1000 micrometer, more preferably in the range of from 0.7 to 500 micrometer. Generally, a suitable gas can be fed co-current or counter-current with the solid precursor compound aero through the plasma torch. Preferred conditions suitable to form an electride compound are described herein below.

Preferably, according to the present invention, the heating according to (ii) is carried out in a batch process using an electric arc furnace which comprises a first electrode and a second electrode between which the electric arc is formed, wherein on the second electrode, the precursor compound to be heated is positioned, and wherein during heating according to (ii), the electrical power of the light arc between the first electrode and the second electrode is preferably in the range of from 100 to 4000 W (Watt), more preferably in the range of from 500 to 3000 W, more preferably in the range of from 750 to 2000 W. Preferred ranges include, for example, from 750 to 1250 W or from 1000 to 1500 W or from 1250 to 1750 W or from 1500 to 2000 W.

Depending on the scale, the electrical power of the light arc between the first electrode and the second electrode may range in the range of from 100 to 4,000,000 W (Watt), more preferably in the range of from 500 to 300,000 W, more preferably in the range of from 750 to 100,000 W.

Preferably, the electric arc furnace further comprises a gas-tight housing enclosing the first electrode and the second electrode, and further enclosing the gas atmosphere according to (ii). More preferably, the first electrode is positioned vertically above the second electrode, and the gas-tight housing comprises means for at least partially removing a gas atmosphere from the housing and for feeding a gas atmosphere into the housing.

The first electrode preferably comprises tungsten, a mixture of tungsten with zirconium oxide, a mixture of tungsten with thorium oxide, a mixture of tungsten with lanthanum oxide, or a mixture of tungsten with copper, preferably comprises tungsten, more preferably is a tungsten electrode. If zirconium oxide is comprised in addition to tungsten, it may be preferred that the electrode comprises from 0.15 to 0.9 weight-% zirconium oxide. If thorium oxide is comprised in addition to tungsten, it may be preferred that the electrode comprises from 0.35 to 4.2 weight-% thorium oxide. If lanthanum oxide is comprised in addition to tungsten, it may be preferred that the electrode comprises from 0.8 to 2.2 weight-% lanthanum oxide. If copper is comprised in addition to tungsten, it may be preferred that the electrode comprises from 10 to 50 weight-% cooper. It is further conceivable that the first electrode comprises tantalum, niobium, molybdenum, carbon, borides such as lanthanum hexaboride, calcium hexaboride, cerium hexaboride, carbides such as tungsten carbide, or titanium carbide. Preferably, the first electrode is the cathode.

The second electrode preferably comprises one or more of metals selected from the group consisting of tungsten, copper, niobium, molybdenum, tantalum, and chromium, preferably comprises copper, more preferably is a copper electrode. If two or more metals are comprised in the second electrode, the electrode may contain an alloy of two or more of these metals. Preferably, the second electrode is the anode.

Preferably, according to (ii), the precursor compound is heated under plasma forming conditions for a period of time in the range of from 1 to 180 s, more preferably in the range of from 2 to 120 s, more preferably in the range of from 5 to 90 s.

Preferably during heating the composition provided in (i) under plasma forming conditions according to (ii), the gas atmosphere has a pressure of less than 1 bar(abs), more preferably in the range of from 0.3 to 0.9 bar(abs), more preferably in the range of from 0.6 to 0.8 bar(abs). According to a further embodiment, the gas atmosphere preferably has a pressure of at least 1 bar(abs), more preferably in the range of from 1 to 30 bar(abs), more preferably in the range of from 2 to 10 bar(abs). According to a further embodiment, the gas atmosphere preferably has a pressure in the range of from 0.3 to 30 bar(abs), more preferably in the range of from 0.6 to 10 bar (abs).

At the beginning of the heating according to (ii), the temperature of the gas atmosphere is preferably in the range of from 10 to 50° C., more preferably in the range of from 15 to 40° C., more preferably in the range of from 20 to 30° C.

Preferably, heating the composition provided in (i) under plasma forming conditions according to (ii) is carried out under oxygen (O₂) removal conditions. It is preferred that the oxygen removal conditions comprise either physical oxygen removal conditions and/or chemical oxygen removal conditions. Preferably, the chemical oxygen removal conditions comprise a gas atmosphere according to (ii) which comprises an oxygen reducing gas. Preferably, the oxygen reducing gas comprises one or more of nitrogen (N₂), carbon monoxide (CO), methane and hydrogen (H₂), preferably comprises, more preferably consists of hydrogen. Preferably, at least 0.5 volume-%, more preferably at least 5 volume-%, more preferably at least 50 volume-%, of the gas atmosphere consist of hydrogen. It may be preferred that at least 70 volume-%, more preferably at least 80 volume-%, more preferably at least 90 volume-% of the gas atmosphere consist of hydrogen.

The gas atmosphere according to (ii) preferably comprises a gas which is ionizable under the plasma forming conditions according to (ii). Preferably, the gas which is ionizable under the plasma forming conditions comprises one or more noble gases, more preferably one or more of helium, neon, argon, krypton, xenon, more preferably one or more of helium, neon and argon, wherein more preferably, the gas which is ionizable under the plasma forming conditions comprises argon. Preferably at least 99 volume-%, more preferably at least 99.5 volume-%, more preferably at least 99.9 volume-% of the gas which is ionizable under the plasma forming conditions consist of argon.

Preferably, the gas atmosphere according to (ii) comprises an oxygen reducing gas and a gas which is ionizable under the plasma forming conditions, wherein at the beginning of the heating according to (ii) in the gas atmosphere, the volume ratio of the oxygen reducing gas relative to the gas which is ionizable under the plasma forming conditions is preferably in the range of from 1:99 to 10:90, more preferably in the range of from 2:98 to 8:92, more preferably in the range of from 4:96 to 6:94. Preferably, at the beginning of the heating according to (ii), at least 99 volume-%, more preferably at least 99.5 volume-%, more preferably at least 99.9 volume-% of the gas atmosphere consist of the oxygen reducing gas and the gas which is ionizable under the plasma forming conditions.

There are no specific restrictions regarding the physical oxygen removal conditions. Preferably, the physical oxygen removal conditions comprise
(ii.1) heating the composition provided in (i) in the gas atmosphere under plasma forming conditions for a period of time delta₁t, wherein the gas atmosphere comprises a gas which is ionizable under the plasma forming;
(ii.2) at least partially removing the gas atmosphere after the period of time deltaₗt and providing a fresh gas atmosphere comprising a gas which is ionizable under the plasma forming conditions;
(ii.3) further heating of the composition obtained from (ii.2) in the fresh gas atmosphere under plasma forming conditions for a period of time delta₂t.

If physical oxygen removal conditions are realized, the gas atmosphere according to (ii.1) preferably comprises a gas which is ionizable under the plasma forming conditions according to (ii.1). Preferably, the gas which is ionizable under the plasma forming conditions comprises one or more noble gases, more preferably one or more of helium, neon, argon, krypton, xenon, more preferably one or more of helium, neon and argon, wherein more preferably, the gas which is ionizable under the plasma forming conditions comprises argon. Preferably at least 99 volume-%, more preferably at least 99.5 volume-%, more preferably at least 99.9 volume-% of the gas which is ionizable under the plasma forming conditions consist of argon. Further, if physical oxygen removal conditions are realized, these conditions are combined with chemical oxygen removal conditions, and the gas atmosphere according to (ii.1) preferably further comprises an oxygen reducing gas which preferably comprises one or more of nitrogen (N₂) and hydrogen (H₂), more preferably comprises, more preferably consists of hydrogen. Preferably, at the beginning of the heating in the gas atmosphere according to (ii.1), the volume ratio of the oxygen reducing gas relative to the gas which is ionizable under plasma forming conditions according to (ii.1) is in the range of from 1:99 to 10:90, more preferably in the range of from 2:98 to 8:92, more preferably in the range of from 4:96 to 6:94. Preferably, at the beginning of the heating in the gas atmosphere according to (ii.1), the volume ratio of the oxygen reducing gas relative to the gas which is ionizable under plasma forming conditions according to (ii.1) is in the range of from 0:100 to 1:99, more preferably in the range of from 0:100 to 0.5:99.5, more preferably in the range of from 0:100 to 0.1:99.9. At the beginning of the heating according to (ii.1), preferably at least 99 volume-%, more preferably at least 99.5 weight-%, more preferably at least 99.9 weight-% of the gas atmosphere consist of the gas which is ionizable under the plasma forming conditions and optionally the oxygen reducing gas. At the beginning of the heating according to (ii.1), the temperature of the gas atmosphere is in the range of from 10 to 50° C., preferably in the range of from 15 to 40° C., more preferably in the range of from 20 to 30° C. If physical oxygen removal conditions are realized, the gas atmosphere according to (ii.3) preferably comprises a gas which is ionizable under the plasma forming conditions according to (ii.3). Preferably, the gas which is ionizable under the plasma forming conditions comprises one or more noble gases, more preferably one or more of helium, neon, argon, krypton, xenon, more preferably one or more of helium, neon and argon, wherein more preferably, the gas which is ionizable under the plasma forming conditions comprises argon. Preferably at least 99 volume-%, more preferably at least 99.5 volume-%, more preferably at least 99.9 volume-% of the gas which is ionizable under the plasma forming conditions consist of argon. Further, if physical oxygen removal conditions are realized, these conditions are combined with chemical oxygen removal conditions, and the gas atmosphere according to (ii.3) preferably further comprises an oxygen reducing gas which preferably comprises one or more of nitrogen (N₂) and hydrogen (H₂), more preferably comprises, more preferably consists of hydrogen. Preferably, at the beginning of the heating in the gas atmosphere according to (ii.3), the volume ratio of the oxygen reducing gas relative to the gas which is ionizable under plasma forming conditions according to (ii.3) is in the range of from 1:99 to 10:90, more preferably in the range of from 2:98 to 8:92, more preferably in the range of from 4:96 to 6:94. Preferably, at the beginning of the heating in the gas atmosphere according to (ii.3), the volume ratio of the oxygen reducing gas relative to the gas which is ionizable under plasma forming conditions according to (ii.3) is in the range of from 0:100 to 1:99, more preferably in the range of from 0:100 to 0.5:99.5, more preferably in the range of from 0:100 to 0.1:99.9. At the beginning of the heating according to (ii.3), preferably at least 99 volume-%, more preferably at least 99.5 weight-%, more preferably at least 99.9 weight-% of the gas atmosphere consist of the gas which is ionizable under the plasma forming conditions and optionally the oxygen reducing gas. At the beginning of the heating according to (ii.3), the temperature of the gas atmosphere is in the range of from 10 to 50° C., preferably in the range of from 15 to 40° C., more preferably in the range of from 20 to 30° C.

Preferably, the sum of deltaₗt and delta₂t, (delta₁t+delta₂t), according to (ii.1) and (ii.3) is in the range of from 1 to 180 s, more preferably in the range of from 2 to 120 s, more preferably in the range of from 5 to 90 s.

After (ii.3), it may be preferred that the sequence (a) removing the gas atmosphere and providing a fresh gas atmosphere and (b) further heating the composition in the fresh gas atmosphere is repeated at least once, wherein for each step (b), there is a period of time delta_{b}t for which the composition obtained from (a) is heated under plasma forming conditions. Preferably, the total heating time according to (ii), which is defined as the sum of deltaₗt, delta₂t, and all delta_{b}t, is preferably in the range of from 1 to 180 s, more preferably in the range of from 2 to 120 s, more preferably in the range of from 5 to 90 s. For example, after (ii.3), the sequence (a) removing the gas atmosphere and providing a fresh gas atmosphere and (b) further heating the composition in the fresh gas atmosphere can be repeated once, twice, three times, four times, five times, six times, seven times, eight times, nine times, ten times.

After the last heating under plasma conditions, the electride obtained from (ii) is preferably cooled, and the process of the present invention preferably further comprises
(iii) cooling the electride obtained from (ii),
   preferably to a temperature in the range of from 10 to 50° C.

The present invention further relates to an oxidic compound comprising an oxidic compound of the gamet group which comprises calcium and aluminum, obtainable or obtained by a process as described above, comprising steps (i.1), optionally (i.2), and (i.3). Preferably, the present invention further relates to an oxidic compound comprising an oxidic compound of the gamet group which comprises calcium and aluminum, obtainable or obtained by a process as described above, comprising steps (i.1) and (i.3) wherein after (i.1) and prior to (i.3), the hydrothermal treatment according to (i.2) is not carried out. Preferably at least 90 weight-%, preferably at least 95 weight-%, more preferably at least 99 weight-%, more preferably at least 99.5 weight-%, more preferably at least 99.9 weight-% of the oxidic compound of the gamet group consist of calcium, aluminum, and oxygen, and the oxidic compound of the gamet group may additionally comprise one or more of magnesium, gallium, silicon, germanium, tin, strontium, titanium, zirconium, chromium, manganese, iron, cobalt, nickel, copper, and zinc. Further, the oxidic compound of the garnet group preferably comprises calcium and aluminum at an elemental ratio Ca:Al in the range of from 11.5:14 to 12.5:14, preferably in the range of from 11.8:14 to 12.2:14, more preferably in the range of from 11.9:14 to 12.1:14, more preferably at an elemental ratio Ca:Al of 12:14. Further, the oxidic compound of the gamet group preferably comprises calcium and oxygen at an elemental ratio Ca:O in the range of from 11.5:33 to 12.5:33, more preferably in the range of from 11.8:33 to 12.2:33, more preferably in the range of from 11.9:33 to 12.1:33, more preferably at an elemental ratio Ca:O 12:33. Preferably, the oxidic compound of the garnet group is a crystalline material exhibiting cubic structure and crystallographic space group 1-43d, wherein more preferably, the oxidic compound of the gamet group comprises, more preferably is a mayenite, more preferably comprises, more preferably is a compound Ca₁₂Al₁₄O₃₃. Preferably, in the oxidic compound, side phases may occur which can be oxides or hydroxides of the single oxides or of a mixed oxide phase. Examples of such side phases include, but are not restricted to, calcium oxide, aluminum oxides like alpha alumina, theta alumina or gamma alumina, mixed calcium aluminum oxides like Ca₃Al₂O₆ (tricalcium aluminate) or CaAl₂O₃ (krotite). Preferably, at least 80 weight-%, more preferably at least 85 weight-%, more preferably at least 90 weight-%, more preferably at least 95 weight-%, more preferably at least 99 weight-% of the oxidic compound consist of an oxidic compound of the garnet group. Preferably, the oxidic compound has a BET specific surface area, determined according to ISO 9277 via physisorption of nitrogen at 77 K, of at least 2 m²/g, more preferably of at least 3 m²/g, more preferably of at least 5 m²/g, such in the range of from 2 to 1000 m²/g, or in the range of from 3 to 1000 m²/g, or in the range of from 5 to 1000 m²/g, more preferably in the range of from 5 to 500 m²/g, more preferably in the range of from 5 to 100 m²/g. Generally, the oxidic compound can be in the form of a powder having a particle size in the sub-micrometer range. Preferably, the oxidic compound is in the form of particles having a mean particle size, determined as described in Reference Example 1.6, in the range of from 1 to 2000 micrometer, more preferably in the range of from 10 to 500 micrometer, more preferably in the range of from 20 to 200 micrometer. The present invention further relates to the use of said oxidic compound for preparing an electride compound.

Yet further, the present invention relates to an electride compound, obtainable or obtained or preparable or prepared by a process as described above, comprising steps (i) and (ii), preferably steps (i), (ii), and (iii).

Still further, the present invention relates to an electride compound, exhibiting an XRD pattern comprising a 211 reflection and a 420 reflection, wherein the intensity ratio of the 211 reflection relative to the 420 reflection is greater than 1:1, preferably in the range of from 1.1:1 to 2.1:1, more preferably in the range of from 1.3:1 to 2.1:1, determined as described in Reference Example 1.2. Further, the electride compound preferably exhibits an EPR spectrum comprising resonances in the range of from 335 to 345 mT, determined as described in Reference Example 1.3. This electride compound is preferably an electride compound, obtainable or obtained or preparable or prepared by a process as described above, comprising steps (i) and (ii), preferably steps (i), (ii), and (iii).

Generally, the electride compound described above can be employed for every conceivable use. Preferably, it is used as a catalyst or as a catalyst component, preferably as a basic catalyst or as a basic catalyst component. Preferably, it is used as a catalyst or as a catalyst component in a chemical reaction comprising hydrogen (H₂) activation, nitrogen activation (N₂), or in an amination reaction. Preferably, it is used as a catalyst or as a catalyst component in a hydrogenation reaction, more preferably for the hydrogenation of an olefin, an aromatic compound, an acetylenic compound, an aldehyde, a carboxylic acid, an ester, an imine, a nitrile, a nitro compound (a compound comprising a nitro group (—NO₂)), nitric acid, a carboxylic acid chloride, an ether and/or an acetal. Preferably, it is used as a catalyst or as a catalyst component for preparing ammonia starting from nitrogen and hydrogen. Therefore, the present invention also relates to a method for activating hydrogen (H₂) or nitrogen (N₂) in a chemical reaction, comprising bringing said hydrogen in contact with a catalyst comprising said electride compound, preferably to said method comprising a hydrogenation reaction, more preferably the hydrogenation of an olefin, an aromatic compound, an acetylenic compound, an aldehyde, a carboxylic acid, an ester, an imine, a nitrile, a nitro compound, nitric acid, a carboxylic acid chloride, an ether and/or an acetal, and to a method for preparing ammonia, comprising bringing a mixture comprising nitrogen and hydrogen in contact with a catalyst comprising the electride compound.

The present invention is further illustrated by the following embodiments and combinations of embodiments as indicated by the respective dependencies and back-references. In particular, it is noted that if a range of embodiments is mentioned, for example in the context of a term such as “The process of any one of embodiments 1 to 4”, every embodiment in this range is meant to be disclosed for the skilled person, i.e. the wording of this term is to be understood by the skilled person as being synonymous to “The process of any one of embodiments 1, 2, 3, and 4”.
1. A process for preparing an electride compound, comprising
   (i) providing a precursor compound of the electride compound, wherein the precursor compound comprises an oxidic compound of the garnet group;
   (ii) heating the precursor compound provided in (i) under plasma forming conditions in a gas atmosphere to a temperature of the precursor compound above the Hüttig temperature of the precursor compound, obtaining the electride compound.
2. The process of embodiment 1, wherein according to (ii), heating the precursor compound under plasma forming conditions comprises heating the precursor compound in an electric arc.
3. The process of embodiment 2, comprising
   (i) providing a precursor compound comprising an oxidic compound of the garnet group;
   (ii) heating the precursor provided in (i) in an electric arc in a gas atmosphere to a temperature of the precursor compound above the Hüttig temperature of the precursor compound, obtaining the electride compound.
4. The process of any one of embodiments 1 to 3, wherein according to (ii), the precursor compound provided in (i) is heated to a temperature of the precursor compound above the Tamman temperature of the precursor compound.
5. The process of any one of embodiments 1 to 4, wherein according to (ii), the precursor compound provided in (i) is heated to a temperature of the precursor compound above the melting temperature of the precursor compound.
6. The process of any one of embodiments 1 to 5, wherein the oxidic compound of the garnet group according to (i) comprises aluminum.
7. The process of any one of embodiments 1 to 6, wherein the oxidic compound of the garnet group according to (i) comprises calcium.
8. The process of any one of embodiments 1 to 7, wherein the oxidic compound of the garnet group according to (i) comprises one or more of magnesium, gallium, silicon, germanium, tin, strontium, titanium, zirconium, chromium, manganese, iron, cobalt, nickel, copper, and zinc.
9. The process of any one of embodiments 1 to 8, wherein at least 90 weight-%, preferably at least 95 weight-%, more preferably at least 99 weight-%, more preferably at least 99.5 weight-%, more preferably at least 99.9 weight-% of the oxidic compound of the garnet group consist of calcium, aluminum, and oxygen.
10. The process of any one of embodiments 1 to 9, wherein the oxidic compound of the garnet group according to (i) comprises calcium and aluminum at an elemental ratio Ca:Al in the range of from 11.5:14 to 12.5:14, preferably in the range of from 11.8:14 to 12.2:14, more preferably in the range of from 11.9:14 to 12.1:14.
11. The process of any one of embodiments 1 to 10, wherein the oxidic compound of the garnet group according to (i) comprises calcium and aluminum at an elemental ratio Ca:Al of 12:14.
12. The process of any one of embodiments 1 to 11, wherein the oxidic compound of the garnet group according to (i) comprises calcium and oxygen at an elemental ratio Ca:O in the range of from 11.5:33 to 12.5:33, preferably in the range of from 11.8:33 to 12.2:33, more preferably in the range of from 11.9:33 to 12.1:33.
13. The process of any one of embodiments 1 to 12, wherein the oxidic compound of the garnet group according to (i) comprises calcium and oxygen at an elemental ratio Ca:O of 12:33.
14. The process of any one of embodiments 1 to 13, wherein the oxidic compound of the garnet group is a crystalline material exhibiting cubic structure and crystallographic space group I-43d.
15. The process of any one of embodiments 1 to 14, wherein the oxidic compound of the garnet group comprises, preferably is a mayenite.
16. The process of any one of embodiments 1 to 15, wherein the oxidic compound of the garnet group comprises, preferably is a compound Ca₁₂Al₁₄O₃.
17. The process of any one of embodiments 1 to 16, wherein at least 80 weight-%, preferably at least 85 weight-%, more preferably at least 90 weight-%, more preferably at least 95 weight-%, more preferably at least 99 weight-% of the precursor compound consist of an oxidic compound of the garnet group.
18. The process of any one of embodiments 1 to 17, wherein the precursor compound has a BET specific surface area, determined according to ISO 9277, of at least 2 m²/g, preferably of at least 3 m²/g, more preferably of at least 5 m²/g, more preferably in the range of from 5 to 1000 m²/g, more preferably in the range of from 5 to 500 m²/g, more preferably in the range of from 5 to 100 m²/g.
19. The process of any one of embodiments 1 to 18, wherein the precursor compound provided according to (i) is in the form of particles having a mean particle size, determined as described in Reference Example 1.6, in the range of from 1 to 2000 micrometer, preferably in the range of from 10 to 500 micrometer, more preferably in the range of from 20 to 200 micrometer.
20. The process of any one of embodiments 1 to 19, wherein providing the precursor compound according to (i) comprises
   (i.1) preparing a mixture comprising a source of calcium, a source of aluminum, and water;
   (i.2) optionally subjecting the mixture prepared in (i.1) to a hydrothermal treatment;
   (i.3) calcining the mixture prepared in (i.1), optionally the mixture obtained from (i.2), obtaining the precursor compound.
21. The process of embodiment 20, wherein the source of calcium is one or more of a calcium oxide, a calcium hydroxide, a hydrated calcium oxide, and a calcium carbonate.
22. The process of embodiment 20 or 21, wherein the source of calcium is a calcium oxide, preferably CaO.
23. The process of any one of embodiments 20 to 22, wherein the source of aluminum is one or more of an aluminum hydroxide including one or more of gibbsite, hydrargillite, bayerite, doyleite, nordstrandite, and gel-like amorphous aluminum hydroxide, an aluminum oxyhydroxide (AlO(OH)) including one or more of pseudo-boehmite, boehmite, diaspor, and akdalaite, and an aluminum oxide including one or more of gamma aluminum oxide, chi aluminum oxide, delta aluminum oxide, eta aluminum oxide, rho aluminum oxide and kappa aluminum oxide.
24. The process of any one of embodiments 20 to 23, wherein the source of aluminum is one or more of gamma alumina, gamma aluminum oxyhydroxide (boehmite) and a pseudo boehmite, preferably gamma aluminum oxyhydroxide.
25. The process of any one of embodiments 20 to 24, wherein in the mixture prepared in (i.1), the molar ratio of the source of calcium relative to the source of aluminum, preferably the molar ratio of the calcium oxide relative to the gamma aluminum oxyhydroxide, is in the range of from 11.90:14 to 12.10:14, preferably in the range of from 11.95 to 12.05:14, more preferably in the range of from 11.99:14 to 12.01:14.
26. The process of any one of embodiments 20 to 25, wherein in the mixture prepared in (i.1), the molar ratio of the source of calcium relative to the source of aluminum, preferably the molar ratio of the calcium oxide relative to the gamma aluminum oxyhydroxide, is 12.00:14.00.
27. The process of any one of embodiments 20 to 26,
   wherein in the mixture prepared in (i.1), the molar ratio of the water relative to the source of aluminum, preferably the gamma aluminum oxyhydroxide, calculated as elemental aluminum, is in the range of from 0.1:1 to 50:1, preferably in the range of from 0.2:1 to 30:1, more preferably in the range of from 0.3:1 to 20:1, more preferably in the range of from 0.5:1 to 10:1.
28. The process of any one of embodiments 20 to 27, wherein preparing the mixture according to (i.1) comprises agitating the mixture, preferably mechanically agitating the mixture.
29. The process of embodiment 28, wherein agitating the mixture comprises milling the mixture.
30. The process of any one of embodiments 20 to 29, wherein according to (i.3), the mixture is calcined in a gas atmosphere, wherein the gas atmosphere comprises oxygen, wherein more preferably, the gas atmosphere is oxygen, air, lean air, or synthetic air.
31. The process of embodiment 30, wherein the gas atmosphere is a gas stream and the mixture is calcined at a flow rate of the gas stream in the range of from 1 to 10 L/min, preferably in the range of from 3 to 9 L/min, more preferably in the range of from 5 to 8 L/min.
32. The process of embodiment 30 or 31, wherein the calcining is carried out at a temperature in the range of from 400 to 1400° C., preferably in the range of from 500 to 1350° C., more preferably in the range of from 600 to 1300° C., more preferably in the range of from 700 to 1300° C., more preferably in the range of from 750 to 1250° C.
33. The process of embodiment 32, wherein the mixture is heated to the temperature at a heating rate in the range of from 1 to 8 K/min, preferably in the range of from 2 to 7 K/min, more preferably in the range of from 3 to 6 K/min.
34. The process of any one of embodiments 20 to 33, wherein according to (i.2), the mixture prepared in (i.1) is subjected to a hydrothermal treatment.
35. The process of embodiment 34, wherein according to (i.2), the mixture is heated under autogenous pressure, preferably in an autoclave, to a temperature in the range of from 35 to 250° C., preferably in the range of from 40 to 200° C., more preferably in the range of from 50 to 150° C.
36. The process of embodiment 35, wherein the mixture is kept at this temperature for a period of time of at most 90 h, preferably at most 70 h, more preferably at most 50 h.
37. The process of embodiment 35 or 36, wherein the mixture is kept at this temperature for a period of time in the range of from 1 to 90 h, preferably in the range of from 3 to 70 h, more preferably in the range of from 6 to 50 h.
38. The process of any one of embodiment 34 to 37, wherein (i.2) further comprises drying the mixture obtained from the hydrothermal treatment, preferably in a gas atmosphere, wherein the gas atmosphere preferably comprises oxygen, wherein more preferably, the gas atmosphere is oxygen, air, lean air, or synthetic air, and wherein the gas atmosphere has a temperature preferably in the range of from 40 to 150° C., more preferably in the range of from 50 to 120° C., more preferably in the range of from 60 to 100° C.
39. The process of any one of embodiments 34 to 38, wherein in the mixture prepared in (i.1), the molar ratio of the water relative to the source of aluminum, preferably the gamma aluminum oxyhydroxide, calculated as elemental aluminum, is in the range of from 0.1:1 to 50:1, preferably in the range of from 0.2:1 to 30:1, more preferably in the range of from 0.3:1 to 20:1, more preferably in the range of from 0.5:1 to 10:1.
40. The process of any one of embodiments 34 or 39, wherein according to (i.3), the mixture is calcined in a gas atmosphere, wherein the gas atmosphere comprises nitrogen and/or oxygen, wherein more preferably, the gas atmosphere is oxygen, air, lean air, or synthetic air.
41. The process of embodiment 40, wherein the gas atmosphere has a temperature in the range of from 400 to 1400° C., preferably in the range of from 400 to 1200° C., more preferably in the range of from 400 to 1000° C., more preferably in the range of from 400 to 800° C.
42. The process of any one of embodiments 20 to 41, further comprising
   (i.4) preparing a molding comprising, preferably consisting of the precursor compound obtained from (i.3).
43. The process of embodiment 42, wherein the molding is in the form of a tablet.
44. The process of any one of embodiments 1 to 43, wherein the heating according to (ii) is carried out in an electric arc furnace which comprises a first electrode and a second electrode between which the electric arc is formed, wherein on the second electrode, the precursor compound to be heated is positioned, and wherein during heating according to (ii), the electrical power of the light arc between the first electrode and the second electrode is in the range of from 100 to 4000 W, preferably in the range of from 500 to 3000 W, more preferably in the range of from 750 to 2000 W.
45. The process of embodiment 44, wherein the electric arc furnace further comprises a gas-tight housing enclosing the first electrode and the second electrode, and further enclosing the gas atmosphere according to (ii), wherein the first electrode is positioned vertically above the second electrode, and wherein the gas-tight housing comprises means for at least partially removing a gas atmosphere from the housing and for feeding a gas atmosphere into the housing.
46. The process of embodiment 44 or 45, wherein the first electrode comprises tungsten, a mixture of tungsten with zirconium oxide, a mixture of tungsten with thorium oxide, a mixture of tungsten with lanthanum oxide, or a mixture of tungsten with copper oxide, preferably comprises tungsten, more preferably is a tungsten electrode, and wherein the second electrode comprises one or more of metals selected from the group consisting of tungsten, copper, niobium, molybdenum, tantalum, and chromium, preferably comprises copper, more preferably is a copper electrode.
47. The process of any one of embodiments 1 to 46, wherein according to (ii), the precursor compound is heated under plasma forming conditions for a period of time in the range of from 1 to 180 s, preferably in the range of from 2 to 120 s, more preferably in the range of from 5 to 90 s.
48. The process of any one of embodiments 1 to 47, wherein during heating the composition provided in (i) under plasma forming conditions according to (ii), the gas atmosphere has a pressure of less than 1 bar(abs), preferably in the range of from 0.3 to 0.9 bar(abs), more preferably in the range of from 0.6 to 0.8 bar(abs), or wherein during heating the composition provided in (i) under plasma forming conditions according to (ii), the gas atmosphere has a pressure of at least 1 bar(abs), preferably in the range of from 1 to 30 bar(abs), more preferably in the range of from 2 to 10 bar(abs).
49. The process of any one of embodiments 1 to 48, wherein at the beginning of the heating according to (ii), the temperature of the gas atmosphere is in the range of from 10 to 50° C., preferably in the range of from 15 to 40° C., more preferably in the range of from 20 to 30° C.
50. The process of any one of embodiments 1 to 49, wherein heating the precursor compound under plasma forming conditions according to (ii) is carried out under oxygen (O₂) removal conditions.
51. The process of embodiment 50, wherein the oxygen removal conditions comprise physical oxygen removal conditions and/or chemical oxygen removal conditions.
52. The process of embodiment 51, wherein the chemical oxygen removal conditions comprise a gas atmosphere according to (ii) which comprises an oxygen reducing gas.
53. The process of embodiment 52, wherein the oxygen reducing gas comprises one or more of nitrogen (N₂), carbon monoxide (CO), methane (CH₄) and hydrogen (H₂), preferably comprises, more preferably consists of hydrogen.
54. The process of embodiment 52 or 53, wherein at least 0.5 volume-%, preferably at least 5 volume-%, more preferably at least 50 volume-% of the gas atmosphere consist of hydrogen.
55. The process of embodiment 52 or 53, wherein the gas atmosphere according to (ii) comprises a gas which is ionizable under the plasma forming conditions according to (ii).
56. The process of embodiment 55, wherein the gas which is ionizable under the plasma forming conditions comprises one or more noble gases, preferably one or more of helium, neon, argon, krypton, xenon, more preferably one or more of helium, neon and argon, wherein more preferably, the gas which is ionizable under the plasma forming conditions comprises argon.
57. The process of embodiment 56, wherein at least 99 volume-%, preferably at least 99.5 volume-%, more preferably at least 99.9 volume-% of the gas which is ionizable under the plasma forming conditions consist of argon.
58. The process of any one of embodiments 52 to 57, wherein the gas atmosphere according to (ii) comprises an oxygen reducing gas and a gas which is ionizable under the plasma forming conditions, wherein at the beginning of the heating according to (ii) in the gas atmosphere, the volume ratio of the oxygen reducing gas relative to the gas which is ionizable under the plasma forming conditions is in the range of from 1:99 to 10:90, preferably in the range of from 2:98 to 8:92, more preferably in the range of from 4:96 to 6:94.
59. The process of embodiment 58, wherein at the beginning of the heating according to (ii), at least 99 volume-%, preferably at least 99.5 volume-%, more preferably at least 99.9 volume-% of the gas atmosphere consist of the oxygen reducing gas and the gas which is ionizable under the plasma forming conditions.
60. The process of any one of embodiment 51 to 59, wherein the physical oxygen removal conditions comprise
   (ii.1) heating the precursor compound provided in (i) in the gas atmosphere under plasma forming conditions for a period of time delta₁t, wherein the gas atmosphere comprises a gas which is ionizable under the plasma forming;
   (ii.2) at least partially removing the gas atmosphere after the period of time delta₁t and providing a fresh gas atmosphere comprising a gas which is ionizable under the plasma forming conditions;
   (ii.3) further heating of the precursor compound obtained from (ii.2) in the fresh gas atmosphere under plasma forming conditions for a period of time delta₂t.
61. The process of embodiment 60, wherein the gas which is ionizable under the plasma forming conditions according to (ii.1) comprises one or more noble gases, preferably one or more of helium, neon, argon, krypton, xenon, more preferably one or more of helium, neon and argon, wherein more preferably, the gas which is ionizable under the plasma forming conditions comprises argon.
62. The process of embodiment 61, wherein at least 99 volume-%, preferably at least 99.5 volume-%, more preferably at least 99.9 volume-% of the gas which is ionizable under the plasma forming conditions according to (ii.1) consist of argon.
63. The process of any one of embodiments 60 to 62, wherein the gas atmosphere according to (ii.1) further comprises an oxygen reducing gas which preferably comprises one or more of nitrogen (N₂) and hydrogen (H₂), more preferably comprises, more preferably consists of hydrogen.
64. The process of embodiment 63, wherein at the beginning of the heating in the gas atmosphere according to (ii.1), the volume ratio of the oxygen reducing gas relative to the gas which is ionizable under plasma forming conditions according to (ii.1) is in the range of from 1:99 to 10:90, preferably in the range of from 2:98 to 8:92, more preferably in the range of from 4:96 to 6:94.
65. The process of embodiment 63, wherein at the beginning of the heating in the gas atmosphere according to (ii.1), the volume ratio of the oxygen reducing gas relative to the gas which is ionizable under plasma forming conditions according to (ii.1) is in the range of from 0:100 to 1:99, preferably in the range of from 0:100 to 0.5:99.5, more preferably in the range of from 0:100 to 0.1:99.9.
66. The process of any one of embodiments 61 to 65, wherein at the beginning of the heating according to (ii.1), at least 99 volume-%, preferably at least 99.5 weight-%, more preferably at least 99.9 weight-% of the gas atmosphere consist of the gas which is ionizable under the plasma forming conditions and optionally the oxygen reducing gas.
67. The process of any one of embodiments 60 to 66, wherein at the beginning of the heating according to (ii.1), the temperature of the gas atmosphere is in the range of from 10 to 50° C., preferably in the range of from 15 to 40° C., more preferably in the range of from 20 to 30° C.
68. The process of any one of embodiments 60 to 67, wherein the gas which is ionizable under the plasma forming conditions according to (ii.3) comprises one or more noble gases, preferably one or more of helium, neon, argon, krypton, xenon, more preferably one or more of helium, neon and argon, wherein more preferably, the gas which is ionizable under the plasma forming conditions comprises argon.
69. The process of embodiment 68, wherein at least 99 volume-%, preferably at least 99.5 volume-%, more preferably at least 99.9 volume-% of the gas which is ionizable under the plasma forming conditions according to (ii.3) consist of argon.
70. The process of embodiment 68 or 69, wherein the gas atmosphere according to (ii.3) further comprises an oxygen reducing gas which preferably comprises one or more of nitrogen (N₂) and hydrogen (H₂), more preferably comprises, more preferably consists of hydrogen.
71. The process of embodiment 70, wherein at the beginning of the heating in the gas atmosphere according to (ii.3), the volume ratio of the oxygen reducing gas relative to the gas which is ionizable under plasma forming conditions according to (ii.3) is in the range of from 1:99 to 10:90, preferably in the range of from 2:98 to 8:92, more preferably in the range of from 4:96 to 6:94.
72. The process of embodiment 71, wherein at the beginning of the heating in the gas atmosphere according to (ii.1), the volume ratio of the oxygen reducing gas relative to the gas which is ionizable under plasma forming conditions according to (ii.3) is in the range of from 0:100 to 1:99, preferably in the range of from 0:100 to 0.5:99.5, more preferably in the range of from 0:100 to 0.1:99.9.
73. The process of any one of embodiments 68 to 72, wherein at the beginning of the heating according to (ii.3), at least 99 volume-%, preferably at least 99.5 weight-%, more preferably at least 99.9 weight-% of the gas atmosphere consist of the gas which is ionizable under the plasma forming conditions and optionally the oxygen reducing gas.
74. The process of any one of embodiments 60 to 73, wherein at the beginning of the heating according to (ii.3), the temperature of the gas atmosphere is in the range of from 10 to 50° C., preferably in the range of from 15 to 40° C., more preferably in the range of from 20 to 30° C.
75. The process of any one of embodiments 60 to 74, wherein (delta₁t+delta₂t) is in the range of from 1 to 180 s, preferably in the range of from 2 to 120 s, more preferably in the range of from 5 to 90 s.
76. The process of any one of embodiments 60 or 75, wherein after (ii.3), removing the gas atmosphere, providing a fresh gas atmosphere and further heating the precursor compound in the fresh gas atmosphere is repeated at least once, wherein the total heating time according to (ii) is preferably in the range of from 1 to 180 s, more preferably in the range of from 2 to 120 s, more preferably in the range of from 5 to 90 s.
77. The process of any one of embodiments 1 to 76, further comprising
   (iii) cooling the electride obtained from (ii).
78. An oxidic compound comprising an oxidic compound of the gamet group which comprises calcium and aluminum, obtainable or obtained by a process according to any one of embodiments 20 to 41, preferably according to any one of embodiments 20 to 33.
79. The oxidic compound of embodiment 78, wherein the oxidic compound of the gamet group according comprises one or more of magnesium, gallium, silicon, germanium, tin, strontium, titanium, zirconium, chromium, manganese, iron, cobalt, nickel, copper, and zinc.
80. The oxidic compound of embodiment 78 or 79, wherein at least 90 weight-%, preferably at least 95 weight-%, more preferably at least 99 weight-%, more preferably at least 99.5 weight-%, more preferably at least 99.9 weight-% of the oxidic compound of the garnet group consist of calcium, aluminum, and oxygen.
81. The oxidic compound of any one of embodiments 78 to 80, wherein the oxidic compound of the gamet group comprises calcium and aluminum at an elemental ratio Ca:Al in the range of from 11.5:14 to 12.5:14, preferably in the range of from 11.8:14 to 12.2:14, more preferably in the range of from 11.9:14 to 12.1:14.
82. The oxidic compound of any one of embodiments 78 to 81, wherein the oxidic compound of the gamet group comprises calcium and aluminum at an elemental ratio Ca:Al of 12:14.
83. The oxidic compound of any one of embodiments 78 to 82, wherein the oxidic compound of the garnet group comprises calcium and oxygen at an elemental ratio Ca:O in the range of from 11.5:33 to 12.5:33, preferably in the range of from 11.8:33 to 12.2:33, more preferably in the range of from 11.9:33 to 12.1:33.
84. The oxidic compound of any one of embodiments 78 to 83, wherein the oxidic compound of the garnet group comprises calcium and oxygen at an elemental ratio Ca:O of 12:33.
85. The oxidic compound of any one of embodiments 78 to 84, wherein the oxidic compound of the gamet group is a crystalline material exhibiting cubic structure and crystallographic space group I-43d.
86. The oxidic compound of any one of embodiments 78 to 85, wherein the oxidic compound of the garnet group comprises, preferably is a mayenite.
87. The oxidic compound of any one of embodiments 78 to 86, wherein the oxidic compound of the gamet group comprises, preferably is a compound Ca₁₂Al₁₄O₃.
88. The oxidic compound of any one of embodiments 78 to 87, wherein at least 80 weight-%, preferably at least 85 weight-%, more preferably at least 90 weight-%, more preferably at least 95 weight-%, more preferably at least 99 weight-% of the oxidic compound consist of an oxidic compound of the gamet group.
89. The oxidic compound of any one of embodiments 88 to 89, wherein the precursor compound has a BET specific surface area, determined according to ISO 9277, of at least 2 m²/g, preferably of at least 3 m²/g, more preferably of at least 5 m²/g, more preferably in the range of from 5 to 1000²/g, more preferably in the range of from 5 to 500 m²/g, more preferably in the range of from 5 to 100 m²/g.
90. The oxidic compound of any one of embodiments 78 to 89, wherein the precursor compound provided according to (i) is in the form of particles having a mean particle size, determined as described in Reference Example 1.6, in the range of from 1 to 2000 micrometer, preferably in the range of from 10 to 500 micrometer, more preferably in the range of from 20 to 200 micrometer.
91. An electride compound, obtainable or obtained or preparable or prepared by a process according to any one of embodiments 1 to 79.
92. An electride compound, preferably the electride compound of embodiment 91, exhibiting an XRD pattern comprising a 211 reflection and a 420 reflection, wherein the intensity ratio of the 211 reflection relative to the 420 reflection is greater than 1:1, preferably in the range of from 1.1:1 to 2.1:1, more preferably in the range of from 1.3:1 to 2.1:1, determined as described in Reference Example 1.2.
93. The electride compound of embodiment 92, exhibiting an EPR spectrum comprising resonances in the range of from 335 to 345 mT, determined as described in Reference Example 1.3.
94. Use of an electride compound according to any one of embodiments 91 to 93 as a catalyst or a catalyst component, preferably as a basic catalyst or as a basic catalyst component.
95. The use of embodiment 94 in a chemical reaction comprising hydrogen (H₂) activation, nitrogen activation (N₂), or in an amination reaction.
96. The use of embodiment 94 or 95 in a hydrogenation reaction, preferably for the hydrogenation of an olefin, an aromatic compound, an acetylenic compound, an aldehyde, a carboxylic acid, an ester, an imine, a nitrile, a nitro compound, nitric acid, a carboxylic acid chloride, an ether and/or an acetal.
97. The use according to embodiment 94 for preparing ammonia starting from nitrogen and hydrogen.
98. A method for activating hydrogen (H₂) or nitrogen (N₂) in a chemical reaction, comprising bringing said hydrogen in contact with a catalyst comprising an electride compound according to any one of embodiments 91 to 93.
99. The method of embodiment 98, comprising a hydrogenation reaction, preferably the hydrogenation of an olefin, an aromatic compound, an acetylenic compound, an aldehyde, a carboxylic acid, an ester, an imine, a nitrile, a nitro compound, nitric acid, a carboxylic acid chloride, an ether and/or an acetal.
100. A method for preparing ammonia, comprising bringing a mixture comprising nitrogen and hydrogen in contact with a catalyst comprising an electride compound according to any one of embodiments 91 to 93.

The present invention is further illustrated by the following reference examples, examples, and comparative examples.

### EXAMPLES

### Reference Example 1: Methods

### Reference Example 1.1: Electric Arc Furnace

For preparing the electride compounds of the present invention, an electric arc furnace MAM-1, Edmund Bühler GmbH, Germany, was used. The general set-up of this furnace is shown in FIG. 1 and FIG. 2. Generally, the electrical arc can be operated at 10 different intensity level settings provided by the apparatus. The respective setting is regulated with a knob at the control unit of the furnace. The electrical power of the respective intensity levels were measured with an ampere- and voltmeter directly connected to the electrodes. The intensity levels of the electrical arc furnace correspond linearly to the electrical power independent from the atmosphere used. This linear dependence is shown in FIG. 3. The values of the electrical power corresponding to the intensity levels are shown in Table 1 below:

TABLE 1
Intensity levels/Electrical power

| Intensity level | Electrical power/W |
|---|---|
| 1 | 110 |
| 2 | 519 |
| 3 | 928 |
| 4 | 1337 |
| 5 | 1746 |
| 6 | 2155 |
| 7 | 2564 |
| 8 | 2973 |
| 9 | 3382 |
| 10 | 3791 |

### Reference Example 1.2: XRD Analysis

The samples of the calcium aluminum oxides and the electride materials based thereon were analyzed regarding their phase purity and crystallinity by XRD using a Bruker D8 Advance diffractometer from Bruker AXS GmbH, Karlsruhe equipped with a Lynxeye XE 1D-Detector, using variable slits, from 5° to 75° 2theta. The anode of the X-ray tube consisted of copper. To suppress the Cu radiation, a nickel filter was used. The following parameters were used:
Voltage: 40 kV
Current: 40 mA
Step size: 0.02° 2theta
Scan speed 0.2 s/step
Soller slits (primary side): 2.5°
Soller slits (secondary side): 2.5°
Divergence slit: 0.17°

### Reference Example 1.3: EPR Analysis

EPR spectra were recorded using a MS100 X-Band-EPR spectrometer from Magnettech GmbH with amplifying and modulation amplitude adjusted to the respective sample. Overview spectra were recorded with a field of 500-4500 G, a sweep time of 41 s and 4096 data points. Quantitative spectra were recorded with a field of 3414 G, a sweep width of 500 G and a sweep time of 41 s in five runs.

### Reference Example 1.4: Preparing the Tablets of the Precursor Compound

Tablets were prepared using a MP250M press, Massen GmbH, Germany, equipped with a pressure gauge. For the preparation of the tablets, 0.5 g of material was used and pressed with a force of 10 t. All tablets prepared were of circular shape, with a diameter of 13 mm and a height of 4 mm.

### Reference Example 1.5: Determination of the Water Content

The water content was analyzed in the drying and ashing system prepASh, Precisa Gravimetrics AG, Switzerland. Samples were heated to 1000° C. and the weight loss was monitored.

### Reference Example 1.6: Determination of Particle Size

The particle size was determined via laser diffraction using a Malvern Mastersizer 3000.

### Reference Example 1.7: Kubelka-Munk Transformed Absorption Spectra

Kubelka-Munk transformed absorption spectra were obtained as follows: UV-Vis reflectance spectra were recorded on a PerkinElmer Lambda 950 Spectrophotometer with an Ulbricht sphere. The obtained reflectance spectra were transformed using the Kubelka-Munk equation:

F(R)=(1−R)²/2R

The electron concentration Nₑ was then determined with the equation according to the literature:

Nₑ=[−(Eₛₚ−Eₛₚ⁰)/0.119]^{0.782}

wherein Eₛₚ⁰=2.83 eV and Eₛₚ is the energy of the respective maxima between 2.5 and 3.0 eV.

### Example 1: Preparing a Precursor Compound Having the Composition Ca₁₂Al₁₄O₃₃

### Materials Used:

AlO(OH) (Disperal®, Boehmite) from Sasol
Calcium oxide (CaO) from Alfa Aesar (ordering number 33299)

The water content was determined as described in Reference Example 1.5. For AlO(OH), an average weight loss of 23.37% was determined, for CaO an average weight loss 3.57%. Table 2 below shows the respective results:

TABLE 2
Weight losses of the starting materials
for preparing the precursor compound

| | mass before heat | mass after heat | weight |
|---|---|---|---|
| | treatment/g | treatment/g | loss/% |
| Disperal ® sample 1 | 1.24 | 0.95 | 23.39 |
| Disperal ® sample 1 | 1.32 | 1.01 | 23.48 |
| Disperal ® sample 1 | 1.21 | 0.93 | 23.14 |
| CaO sample 1 | 1.02 | 0.98 | 3.92 |
| CaO sample 2 | 1.06 | 1.03 | 2.83 |
| CaO sample 3 | 1.01 | 0.97 | 3.96 |

### Materials Used:

| | |
|---|---|
| 0.43 mol | AlO(OH) (Disperal ®, Boehmite) from Sasol |
| 0.37 mol | Calcium oxide (CaO) from Alfa Aesar |
| 4.2 mol | deionized water |

0.43 mole of Al(O)OH (28.4 g, including water content), 0.37 mol (21.6 g, including water content) CaO and 4.2 mol (75.7 g) deionized water were combined in a ZrO₂ 250 mL grinding bowl containing 15 Y-stabilized ZrO₂ grinding balls (diameter 20 mm). The bowl was sealed and the mixture ground four times for 10 min each (600 rpm, alternating rotational direction) in a planetary ball mill (“Pulverisette 6 classic line”, Fritsch GmbH), allowing the mixture to cool for five minutes after each grinding procedure. After the final milling run the grinding bowl was left to cool down for 25 min, then opened and the colourless paste transferred to porcelain bowl. The mixture was then calcined in a muffle furnace (M110, Thermo Fisher Scientific Inc.) by raising the temperature at the rate of 5 K/min to 900° C. and keeping it for 8 h under a flow of clean dry air (CDA) with a flow rate of 6 L/min. 50 g of phase pure mayenite were obtained, which was determined by XRD as described in Reference Example 1.2. The XRD diffraction pattern is shown in FIG. 4.

The calcium aluminum oxides are characterized by the intensity ratios of the 211 (18.0° 2theta) and 420 (33.4° 2 theta) reflections in their respective diffractograms. In calcium aluminum oxides with mayenite structures the intensity ratio of the 211/420 reflections is below one. The compound prepared according to Example 1 showed an intensity ratio of the 211 reflection relative to the 420 reflection of 0.99:1.

### Example 2: Preparing a Calcium Aluminate Having the Composition Ca₁₂Al₁₄O₃₃ (Hydrothermal)

### Materials Used:

| | |
|---|---|
| 0.34 mol | AlO(OH) (Disperal ®, Boehmite) from Sasol |
| 17.3 g | Calcium oxide (CaO) from Alfa Aesar |
| 60.4 g | Deionized water |

0.34 mol of A(O)OH (22.7 g, including water content), 0.30 mol of CaO (17.3 g including water content) and 3.35 mol (60.4 g) of deionized water were placed in a ceramic vessel with eleven ceramic grinding balls (11 mm diameter). The vessel was sealed and the mixture ground in a planetary ball mill (“Pulverisette 6 classic line”, Fritsch GmbH) for 10 min at 600 rpm. The pasty mixture was transferred to a teflon vessel which was placed in a steel autoclave (“DAB-3”, Berghof Products+Instruments GmbH, Germany). The material was then heated to 100° C. and kept at that temperature for 12 h, yielding a thin white suspension. The product was then transferred to a porcelain bowl and dried at 80° C. under air until a dry crystalline solid was obtained—which was identified as phase pure Ca₃Al₂(OH)₁₂ (katoite) by XRD. The material was then heated to 600° C. with a rate of 5 K/min and kept at that temperature for eight hours under a flow of clean dry air with a flow rate of 6 L/min, yielding 40 g mayenite which was confirmed by XRD.

### Example 3: Preparing an Electride Starting from Mayenite

### 3.1 Preparation of Tablets

### Material Used:

0.5 g mayenite (from Example 1; also possible: from Example 2)

0.5 g finely ground mayenite was placed in a tablet press applicable (MP250M press, Massen GmbH, Germany) for the preparation of tablets with a 13 mm diameter. The material was subjected to a pressure of 10 t, thus yielding a colorless mayenite tablet 13 mm in diameter and about 4 mm in height.

### 3.2 Preparation of an Electride Material Under Ar Atmosphere

The mayenite tablet according to Example 3.1 was placed in the recipient chamber on the copper electrode plate in the electrical arc furnace as described in Reference Example 1.1. The chamber was closed and evacuated for 30 s and afterwards refilled with Ar with an absolute pressure of 1 bar. This procedure was repeated twice to achieve a low oxygen partial pressure.

After the last evacuation cycle, the chamber was refilled with Ar, adjusting an absolute pressure of 0.7 bar on the pressure gauge on the arc oven. The electrical arc was ignited at the intensity level 3 and the tungsten electrode directed at the tablet for 20 seconds which resulted in the formation of a melt. Afterwards, the chamber was evacuated and flooded again with Ar to an absolute pressure of 0.7 bar. The resulting yellowish melting ball was treated three more times for 20 s with an arc intensity level 5. After each arc treatment the recipient chamber was purged, i.e. evacuated for 30 seconds and then flooded with an Ar pressure of 0.7 bar. A final arcing treatment was carried out for 5 seconds at the intensity level 9, ultimately yielding a black melting ball. After cooling, the chamber was opened and the melting ball was removed and crushed.

The XRD pattern of the respectively obtained material is shown in FIG. 5. The calcium aluminum oxides are characterized by the intensity ratios of the 211 (18.0° 2theta) and 420 (33.4° 2 theta) reflections in their respective diffractograms. In calcium aluminum oxides with mayenite structures the intensity ratio of the 211/420 reflections is below one. In mayenite based electrides prepared in the electrical arc furnace, the intensity ratios are in the range of from above 1.3 to 2.1, depending on the concentration of unbound electrons in the material. The compound prepared according to Example 3 showed an intensity ratio of the 211 reflection relative to the 420 reflection of 1.3.

### 3.3 Preparation of an Electride Material Under Ar/H₂ Atmosphere

The mayenite tablet according to Example 3.1 was placed in the recipient chamber on the copper electrode plate in the electrical arc furnace as described in Reference Example 1.1. The chamber was sealed and evacuated for 30 s and then refilled with Ar/H₂ (5 volume-% H₂). This procedure was repeated twice. Finally, an absolute gas pressure of 0.7 bar was adjusted. Following the procedure described in Example 3.1 above, the tablet was treated with the electrical arc at the intensity levels 3 (20 s) and 5 (three times for 20 s). After each treatment, the chamber was evacuated and filled with Ar/H₂ gas (5 volume-% H₂). A final arc treatment was carried out at intensity level 9 for 5 s. The chamber was opened and the black melting ball removed and crushed for further analytical treatments.

The XRD pattern of the respectively obtained material is shown in FIG. 6. The calcium aluminum oxides are characterized by the intensity ratios of the 211 (18.0° 2theta) and 420 (33.4° 2 theta) reflections in their respective diffractograms. In calcium aluminum oxides with mayenite structures the intensity ratio of the 211/420 reflection is below one. In mayenite based electrides prepared in the electrical arc furnace, the intensity ratios are in the range of from above 1.3 to 2.1, depending on the concentration of unbound electrons in the material. The compound prepared according to Example 3 showed an intensity ratio of the 211 reflection relative to the 420 reflection of 1.4. The EPR spectrum of the respectively obtained material is shown in FIG. 7. The electride materials generally exhibited resonances at a field of 335-345 mT which is in excellent agreement with literature data (Matsuishi et al.). To quantify the amount of free electrons in the sample, the spectra were integrated using the FWHH method.

Furthermore, for the respectively obtained material the g value or g factor (from Landé gyromagnetic factor was calculated. g values characterize the magnetic moment of any particle nucleus. The g value relates to the observed magnetic moment of a particle (in this case an electron) to its angular momentum quantum number. It is a proportionality constant. The g value was 1.995, hence falling within the range of 1.995 to 1.997 values characteristic for electrons inside the cages of the mayenite based electrides, confirming once more the successful preparation of the electride material.

The electron concentration of the respectively obtained material is 3.4×10²⁰ electrons per cubic centimetre, according to the UV Vis spectra. Furthermore, the Kubelka-Munk transformed absorption spectrum, obtained as described according to reference example 1.7, is shown in FIG. 7a, thus allowing to determine from the absorbance maxima (maxima corresponding to a certain colour of the material) the measured reflectance spectrum. The resulting transformed spectrum shows a characteristic maxima corresponding to the colour of the electride, having a maxima between 2.5 and 3.00 eV which is typical for mayenite based electrides. Accordingly, also the Kubelka-Munk transformed absorption spectrum confirms the successful preparation of an electride material.

### Example 4: Preparing an Electride Compound Based on Y₃Al₅O₁₂

4.1 Preparing an Yttrium Aluminum Garnet Y₃Al₅O₁₂

The yttrium aluminum gamet Y₃Al₅O₁₂ was prepared via calcination of an aqueous solution consisting of an yttrium nitrate solution and Gilofloc® 83, an aqueous polyaluminum chloride solution having an aluminum content of 12.4 weight-%. For 30 g of the product to be prepared (0.0505 mol), 58.072 g Y₂(NO₃)₃*6 H₂O (0.1516 mol) were filled in a vessel and dissolved in 100 ml deionized water under stirring. Thereafter, 55.05 g Gilofloc® 83 were filled in another vessel, and the yttrium nitrate solution was added. The mixture was then heated to 80° C. and kept at 80° C. for 2 h under stirring (150 r.p.m.). The obtained mixture was transferred in a procelaine bowl and calcined at 450° C. in clean dry air at a flow rate of 6 L/min and then at 1000° C. in clean dry air at a flow rate of 2 L/min. The respective heating and the calcination were performed as follows:
heating to 80° C. at a heating rate of 1 K/min
keeping at 80° C. for 1 h
heating to 150° C. at a heating rate of 1 K/min
keeping at 150° C. for 1 h
heating to 200° C. at a heating rate of 1 K/min
keeping at 200° C. for 1 h
heating to 300° C. at a heating rate of 1 K/min
keeping at 300° C. for 1 h
heating to 350° C. at a heating rate of 1 K/min
keeping at 350° C. for 1 h
heating to 450° C. at a heating rate of 1 K/min
keeping at 450° C. for 1 h
cooling to room temperature
heating to 1000° C. at a heating rate of 5 K/min
keeping at 1000° C. for 4 h
cooling to room temperature

A white crystalline powder was obtained which was analyzed according to XRD as described in Reference Example 1.2. The respective diffractogram is shown in FIG. 8.

The powder was then pressed to 0.5 g tablets having a diameter of 13 mm at a pressure of 10 tons, as described in Reference Example 1.4.

4.2 Preparing an Electride Compound Starting from Yttrium Aluminum Garnet Y₃Al₅O₁₂

A 0.5 g yttrium aluminum garnet tablet, prepared according to example 4.1, was placed in the recipient chamber on the copper electrode plate in the electrical arc furnace as described in Reference Example 1.1. The chamber was evacuated and refilled with Argon to an absolute pressure of 1.5 bar on the pressure gauge on the furnace. This procedure was repeated twice, adjusting an absolute pressure of 0.7 bar argon after the final refilling. The electrical arc was ignited at the intensity level 3, then adjusted to the level 7 and directed at the tablet for 15 s. Afterwards, the chamber was evacuated and refilled with argon to an absolute pressure of 0.7 bar. The pellet was treated again at the intensity level 7 for 15 seconds. Afterwards, the chamber was opened and the pellet removed from the chamber for further investigations. The pellet showed the dark colour which is typical for an electride compound. The XRD showed reflections for the gamet type structure.

### SHORT DESCRIPTION OF THE FIGURES

FIG. 1 shows a schematic drawing illustrating the general principle of the electric arc furnace described in Reference Example 1.1. In particular,
1 stands for the electric furnace recipient
2 stand for the tungsten electrode (cathode)
3 stands for the water-cooled copper anode
4 shows the distance between cathode and anode (about 20 mm)
5 shows the diameter of the anode (101 mm)
6 shows the height of the tungsten electrode (63 mm)
7 shows the height of the housing (158 mm)
8 stands for the housing

FIG. 2 shows a schematic drawing illustrating the general principle of the electric arc furnace described in Reference Example 1.1. In particular,
1 stands for the electric furnace recipient
2 shows the connection to a vacuum pump
3 shows the connection to a gas reservoir (e.g. for Ar or for Ar/H₂)
4 shows an air vent

FIG. 3 shows the linear correlation of the apparatus settings (intensity levels) and the corresponding electric power for two different gas atmospheres in the electric arc furnace.

FIG. 4 shows the XRD pattern of the oxidic compound prepared according to Example 1.

FIG. 5 shows the XRD pattern of the electride compound prepared according to Example 3.2.

FIG. 6 shows the XRD pattern of the electride compound prepared according to Example 3.3.

FIG. 7 shows the EPR spectrum of the electride compound prepared according to Example 3.3.

FIG. 7a shows the Kubelka-Munk transformed absorption spectrum of the electride compound prepared according to Example 3.3.

FIG. 8 shows the XRD pattern of the gamet compound prepared according to Example 4.1.

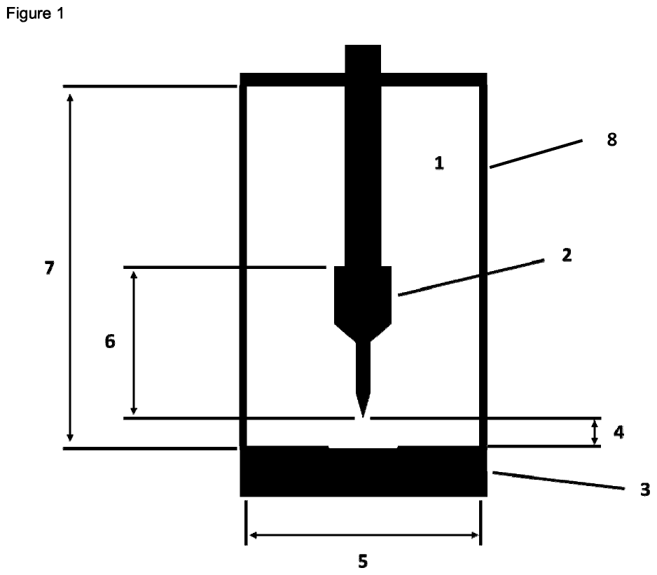

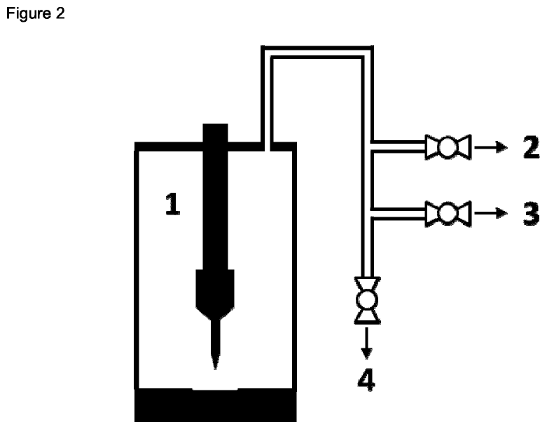

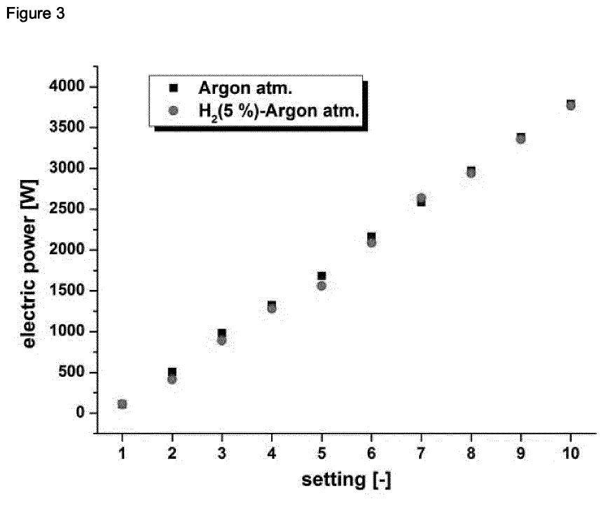

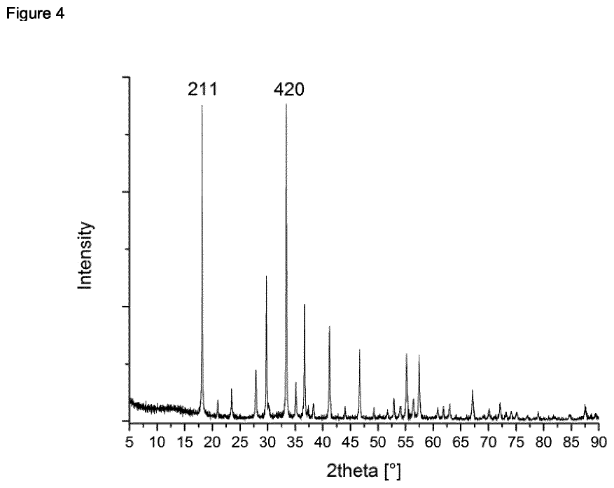

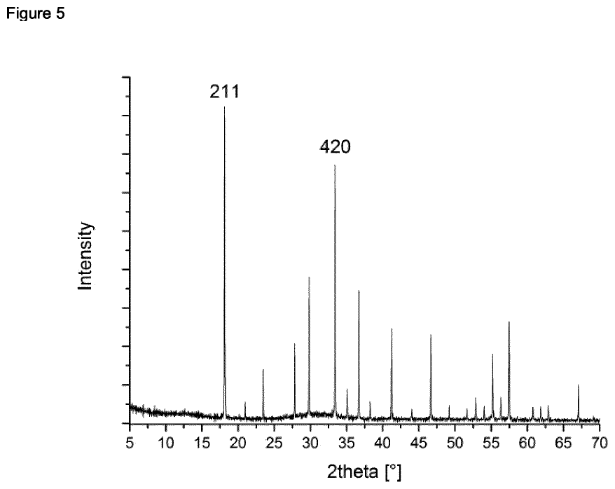

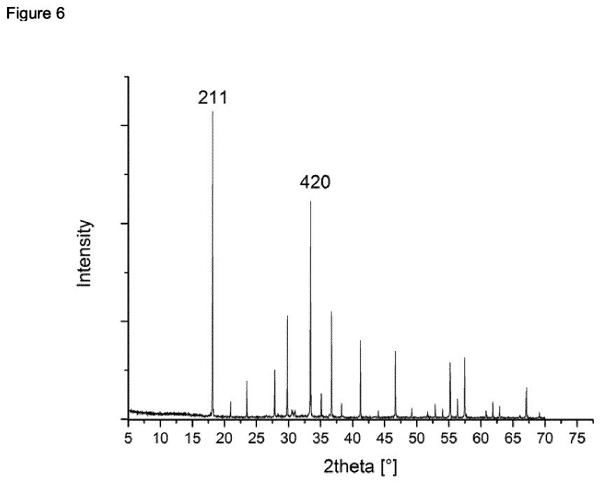

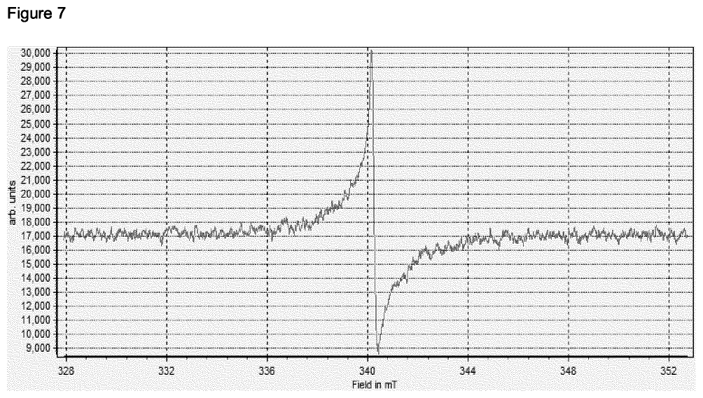

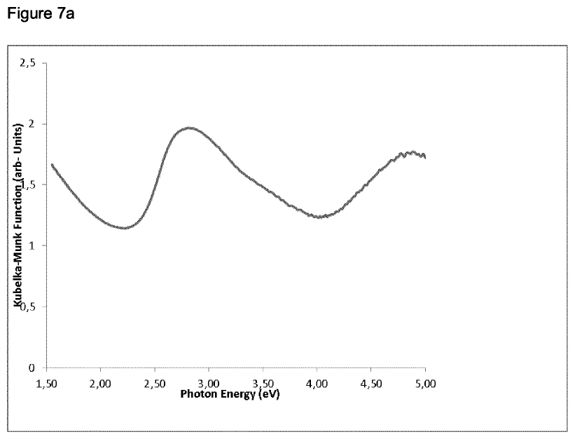

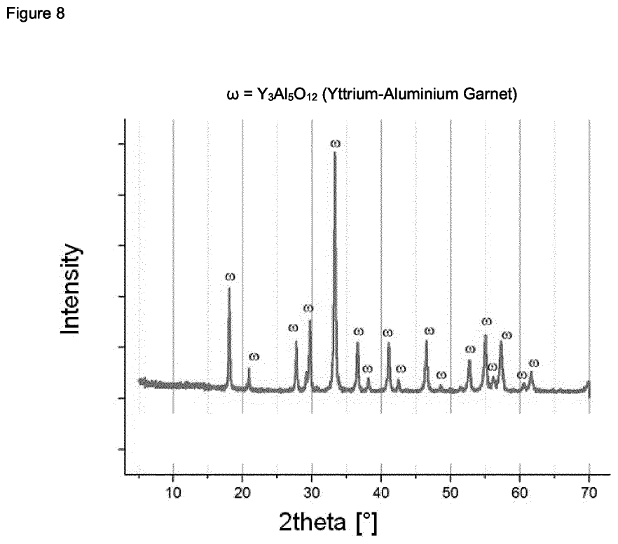

### CITED PRIOR ART

Y. Nishio, K. Nomura, M. Miyakawa, K. Hayashi, H. Yanagi, T. Kamiya, M. Hirano und H. Hosono, “Fabrication and transport properties of 12CaO.7Al2O3 (C12A7) electride nanowire,” Phys. Stat. Sol. (A) (Physica Status Solidi (A)), 2008, pp 2047-2051
J. L. Dye, “Electrons as Anions”, Science, 2003, pp 607-608
J. L. Dye, “Electrides: early examples of quantum confinement”, Acc Chem Res, 2009, pp 1564-1572
US 2006/0151311 A1
US 2009/0224214 A1
US 2015/0217278 A1
E. S. Grew et al., American Mineralogist, vol. 98, 2013, pp 785-211
Matsuishi, S.; Toda, Y.; Miyakawa, M.; Hayashi, K.; Kamiya, T.; Hirano, M.; Tanaka, I.; Hosono, H. Science, 2003, 301, pp 626

1.-15. (canceled)

16. A process for preparing an electride compound, comprising
(i) providing a precursor compound of the electride compound, wherein the precursor compound comprises an oxidic compound of the garnet group;
(ii) heating the precursor compound provided in (i) under plasma forming conditions in a gas atmosphere to a temperature of the precursor compound above the Hüttig temperature of the precursor compound, obtaining the electride compound.

17. The process of claim 16, wherein according to (ii), heating the precursor compound under plasma forming conditions comprises heating the precursor compound in an electric arc.

18. The process of claim 16, wherein the oxidic compound of the garnet group according to (i) comprises aluminum and/or calcium.

19. The process of claim 16, wherein at least 90 weight-% of the precursor compound consist of an oxidic compound of the garnet group.

20. The process of claim 16, wherein providing the precursor compound according to (i) comprises
(i.1) preparing a mixture comprising a source of calcium, a source of aluminum, and water;
(i.2) optionally subjecting the mixture prepared in (i.1) to a hydrothermal treatment;
(i.3) calcining the mixture prepared in (i.1), optionally the mixture obtained from (i.2), obtaining the precursor compound.

21. The process of claim 20, wherein the source of calcium is one or more of a calcium oxide, a calcium hydroxide, a hydrated calcium oxide, and a calcium carbonate, and the source of aluminum is one or more of an aluminum hydroxide including one or more of gibbsite, hydrargillite, bayerite, doyleite, nordstrandite, and gel-like amorphous aluminum hydroxide, an aluminum oxyhydroxide (AlO(OH)) including one or more of pseudo-boehmite, boehmite, diaspor, and akdalaite, and an aluminum oxide including one or more of gamma aluminum oxide, chi aluminum oxide, delta aluminum oxide, eta aluminum oxide, rho aluminum oxide and kappa aluminum oxide.

22. The process of claim 20, wherein according to (i.3), the mixture is calcined in a gas atmosphere, wherein the gas atmosphere comprises oxygen.

23. The process of claim 16, wherein the heating according to (ii) is carried out in an electric arc furnace which comprises a first electrode and a second electrode between which the electric arc is formed, wherein on the second electrode, the precursor compound to be heated is positioned, and wherein during heating according to (ii), the electrical power of the light arc between the first electrode and the second electrode is in the range of from 100 to 4000 W.

24. The process of claim 16, wherein according to (ii), the precursor compound is heated under plasma forming conditions for a period of time in the range of from 1 to 180 s.

25. The process claim 16, wherein heating the precursor compound under plasma forming conditions according to (ii) is carried out under oxygen (O₂) removal conditions, wherein the oxygen removal conditions comprise physical oxygen removal conditions and/or chemical oxygen removal conditions.

26. The process of claim 25, wherein the chemical oxygen removal conditions comprise a gas atmosphere according to (ii) which comprises an oxygen reducing gas, and wherein the gas atmosphere according to (ii) comprises a gas which is ionizable under the plasma forming conditions according to (ii).

27. The process of claim 25, wherein the physical oxygen removal conditions comprise
(ii.1) heating the precursor compound provided in (i) in the gas atmosphere under plasma forming conditions for a period of time delta₁t, wherein the gas atmosphere comprises a gas which is ionizable under the plasma forming;
(ii.2) at least partially removing the gas atmosphere after the period of time delta₁t and providing a fresh gas atmosphere comprising a gas which is ionizable under the plasma forming conditions;
(ii.3) further heating of the precursor compound obtained from (ii.2) in the fresh gas atmosphere under plasma forming conditions for a period of time delta₂t.

28. An electride compound, obtained by the process according to claim 16.

29. An electride compound exhibiting an XRD pattern comprising a 211 reflection and a 420 reflection, wherein the intensity ratio of the 211 reflection relative to the 420 reflection is greater than 1:1, and/or exhibiting an EPR spectrum comprising resonances in the range of from 335 to 345 mT.

30. Use of an electride compound according to claim 28 as a catalyst or a catalyst component.
